(19) United States
(12) Patent Application Publication
(10) Pub. No.: US 2002/0049628 A1
(43) Pub. Date: Apr. 25, 2002

(54) System and method providing automated and interactive consumer information gathering

(76) Inventors: William T. West, San Antonio, TX (US); James H. West, Houston, TX (US); Richard D. Dole, Houston, TX (US); Gary D. Hahs, San Antonio, TX (US); Phylliss P. Stahle, San Antonio, TX (US)

Correspondence Address: Himanshu A. Amin, 24th Floor, National City Center, 1900 East 9th Street, Cleveland, OH, 44114, US

(21) Appl. No.: 09/855,455

(22) Filed: May 15, 2001

Related U.S. Application Data
(60) Provisional application No. 60/242,691, filed on Oct. 23, 2000.

(51) Int. Cl. G06F 17/60

(52) U.S. Cl. 705/10; 705/14

(57) ABSTRACT

The present invention relates to a system and methodology to facilitate real-time generation and retrieval of consumer research information. A point-of-presence interactive system is provided, wherein consumers are motivated to provide information. Incentives such as rewards, rebates, educational/informative information, along with entertainment oriented output is provided to induce consumers to participate in an automated exchange of information. Dynamic feedback is employed by the interactive system to both determine and modify the incentives and information being sought based upon potential profiles of the participant. As information is accumulated from a plurality of participants, the interactive system employs data mining and/or other analysis to provide information consumers such as marketers and researchers with cost-effective and timely research information.

### REFERENCE TO RELATED APPLICATION

This application claims the benefit of U.S. Provisional Patent Application Ser. No. 60/242,691 that was filed Oct. 23, 2000, entitled SYSTEM AND METHOD PROVIDING AUTOMATED AND INTERACTIVE CONSUMER INFORMATION GATHERING.

### TECHNICAL FIELD

The present invention relates generally to computer and information systems, and more particularly to a system and method for enabling cost-effective and timely generation/retrieval of consumer information via a dynamic information gathering and analysis system wherein consumers are interactively engaged to provide marketing/research data.

### BACKGROUND OF THE INVENTION

As business and industries have evolved during the modem technological age, marketing and other research efforts have become increasingly more sophisticated in order to facilitate design and sales of desired products/services to consumers. Because of uncertainties associated with consumer preferences regarding such products and services, billions of dollars are expended annually to better understand these preferences. Thus, demand for usable and timely insights into the minds of consumers has grown rapidly.

A rapidly changing competitive landscape, however, has motivated many businesses to move from a historical model of mass marketing to a modern model more closely associated with one-to-one marketing. New competition from both Internet start-ups and companies outside a firm's traditional competitive arena, such as outside the firm's region, country or industry, has forced many firms to increase understanding of both customers and prospects. Therefore, marketers are now tailoring their offerings to specific needs of small groups and individuals rather than the mass market. Because of the shift in the marketing paradigm, there is a tremendous need to seek consumer information as quickly as possible. Unfortunately, acquiring consumer information has become ever more difficult and expensive.

Potential information providers, such as consumer survey respondents, have become increasingly time-starved and/or less willing to participate in conventional research methods such as focus groups, mail surveys, and phone surveys, etc. Thus, traditional research has become more time-consuming and costly. According to conventional research methods, research has been conducted via focus groups, distributed surveys, over the phone, through the mail and/or over the Internet, for example. These approaches, however, often do not produce cost-effective and useable results.

Focus groups, for example, have become exceedingly difficult to retrieve research information. With the proliferation of two-job families, single parent situations, children's activities, and heightened workplace tensions, focus group recruiting has suffered. Also, the more narrowly defined an audience is, the more difficult recruiting becomes. Personal style and group dynamics may also limit the number of effective group participants. Phone surveys have also become difficult to conduct. Even when potential respondents are home, they are less likely to answer. Identified or not, evening phone calls often are unanswered since they are presumed to be telemarketing calls. Limited patience and language difficulties can also degrade participation and response.

Mail surveys suffer from inherent process slowness to retrieve research results and also suffer from lower participation rates. Questionnaire length and confusing question wording may also cause many willing participant's to abandon and/or give incorrect answers. Although Internet surveys may produce quicker and more cost-effective results, there are still significant limitations. For example, significant portions of the population are still not connected, with access much lower among some important demographic groups. Moreover, many Internet users do not have time or patience to complete an Internet survey. Also, random surveys are difficult to execute because of the need to compete through a clutter of competing web sites, and participants are difficult to identify.

In view of the above problems associated with conventional research systems and methods, there is an unsolved need for a system and/or methodology to facilitate cost-effective generation and retrieval of marketing and research information.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention relates to a system and methodology for obtaining insights into the minds of consumers in order that research, such as marketing, can be conducted in a cost-effective and time-efficient manner. In accordance with the present invention, a motivational interface and analysis system communicates and involves the consumer on both rational and emotional levels via point-of-presence interactive graphics, text, audio and/or video. Real-time information is provided to companies seeking up-to-date information associated with products, services, and/or other areas of sought-after information such as politics, for example. The present invention provides access to consumers who are difficult or sometimes impossible to reach such as teens, ethnic populations, and high-income segments, for example, by interacting at points of interest associated with various groups or populations.

More realistic and richer consumer responses are generally retrieved because the consumer is engaged as a willing participant in the process of providing consumer-specific information. The present invention motivates richer and broader responses by rewarding consumers according to a plurality of incentives offered for research participation and providing participation access to consumers when they have leisure-time and attitude to participate. For example, mobile and/or stand-alone research units may be positioned at a plurality of locations such as at malls, airports, sports venues, universities, convention centers, arts events, etc. Motivation for research participation is enhanced by providing user-specific feedback, entertainment value, an interactive multimedia experience wherein learning opportunities may be embedded, and specific merchandise and/or credit rewards offered for participation. Based upon the type of responses elicited from participants, a dynamic feedback and interpretive analytical system is provided to direct/tailor further questions and incentives that are determined from potential profiles of the participant. Thus, information provided by consumers, may be automatically aggregated and reported from a focused group of likely and/or interested participants.

In accordance with one aspect of the invention, a system providing automatic generation and retrieval of consumer information is provided. The system comprises: an interactive component to motivate consumers to provide information input; and an analytical component providing feedback to the interactive component based upon profiles associated with the information input.

Another aspect of the invention relates to a method providing automatic generation and retrieval of consumer information, comprising: motivating an information provider at a point-of-presence associated with the information provider; utilizing automated feedback to tailor output to the information provider; storing the information provider's response to the output in a database; and data mining the database to retrieve information associated with the information provider.

Another aspect of the invention relates to system for providing automatic generation and retrieval of consumer information, comprising: means for motivating an information provider at a point-of-presence associated with the information provider; means for utilizing automated feedback to tailor output to the information provider; means for storing the information provider's response to the output in a database; and means for data mining the database to retrieve information associated with the information provider.

Yet another aspect of the invention relates to a computer readable medium having computer executable components, comprising: an interactive component to motivate consumers to provide information input; and an analytical component providing feedback to the interactive component based upon profiles associated with the information input.

Still another aspect of the invention relates to a data packet adapted to be transmitted between at least two processes, comprising: an interactive component to motivate consumers to provide information input; and an analytical component providing feedback to the interactive component based upon profiles associated with the information input.

Another aspect of the invention relates to a computer readable medium having stored thereon a data structure, comprising: a first data field containing data representing information provided by consumers in response to interacting with a system to motivate the consumers to provide the information, the consumer motivation being respective functions of profiles of the consumers; and a second data field containing data representing results from an analysis system which analyzed the information based at least upon respective profiles of the consumers.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 is a schematic block diagram illustrating an interactive information generation and retrieval system in accordance with an aspect of the present invention;

FIG. 2 is a schematic block diagram illustrating a mobile interactive information retrieval system in accordance with an aspect of the present invention;

FIG. 3 is a schematic block diagram illustrating a remote interactive information retrieval system in accordance with an aspect of the present invention;

FIG. 4 is a schematic block diagram illustrating a logic engine and data mining subsystem in accordance with an aspect of the present invention;

FIG. 5 is a flow chart diagram illustrating exemplary logic determinations in accordance with an aspect of the present invention;

FIG. 6 is a flow chart diagram illustrating a methodology for providing interactive information generation and retrieval in accordance with an aspect of the present invention; and

FIG. 7 is a schematic block diagram illustrating a suitable computing environment in accordance with an aspect of the present invention.

### DETAILED DESCRIPTION OF THE INVENTION

The present invention is now described with reference to the drawings, wherein like reference numerals are used to refer to like elements throughout.

The present invention relates to a system and methodology to facilitate real-time generation and retrieval of consumer research information. A point-of-presence interactive system is provided, wherein consumers are motivated to provide information. Incentives such as rewards, rebates, educational/informative information, along with entertainment-oriented output is provided to induce consumers to participate in an automated exchange of information. Dynamic feedback is employed by the interactive system to both determine and modify the incentives and information being sought based upon potential profiles of the participant. As information is accumulated from a plurality of participants, the interactive system employs data mining and/or other analysis to provide information consumers such as marketers and researchers with cost-effective and timely research information.

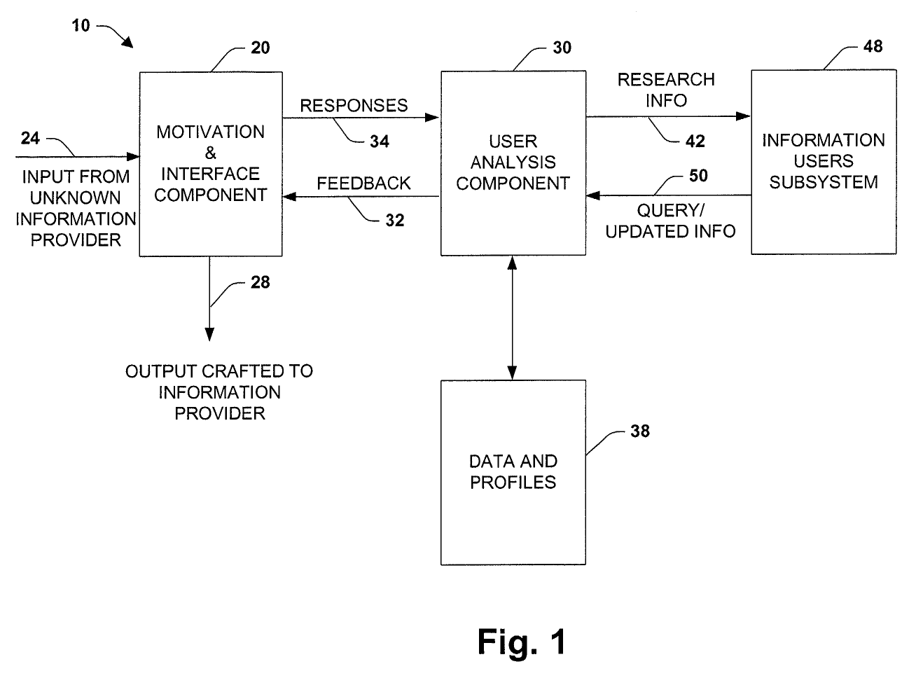

Referring initially to FIG. 1, a system 10 illustrates an aspect of an interactive information generation and retrieval system in accordance with the present invention. A motivation and interface component 20, hereinafter referred to as the MIC, receives consumer information input 24 (e.g., touch-screen, keyboard, voice) from unknown information providers and directs crafted output 28 (e.g., audio, display text, video) to the information provider. The MIC 20 provides a point-of-presence interface wherein users are likely to interact with the system 10. For example, the MIC 20 may be part of a mobile or standalone system that is placed in areas of congregation such as malls, airports, conventions, stadiums, etc. As will be described in more detail below, the MIC 20 may also be provided in remote situations wherein input/output is communicated wirelessly and/or via a network to unknown information providers.

The MIC 20 is driven by a user analysis component 30, wherein feedback 32 is employed to direct and craft/tailor the output 28 to the information provider. The output 28 is utilized to provide a pleasant/positive, entertaining and rewarding experience to the information provider as an incentive for providing input 24 to the MIC 20. For example, the output 28 can be in substantially any form of communications output such as music, video, text, and audio. A plurality of incentives may be offered according to the feedback 32 for participating with (e.g., providing input 24) the MIC 20 via the output 28. For example, text output 28 may be employed wherein the information provider is given an interesting fact (e.g., factoid) and offered a reward for answering correctly. Alternatively, rewards may be offered as an incentive for initially providing input 24 and/or for continued participation with the MIC 20.

Rewards can be in the form of monetary awards, discount offers, rebates, merchandise coupons and/or other credits. Disbursement systems (not shown) such as printers for providing coupons, and cash dispensers for providing money may be employed to distribute the rewards. Alternatively, rewards may be provided to the information provider at a later time such as in the form of a check or coupon delivered in the mail to the information provider's address. Rewards can also be provided in the form of entertainment. For example, the output 28 may direct the user in the form of a challenge. Challenges may be offered in the form of brain-teasers, multilevel quizzes, video games, and/or other entertainment-oriented activities, wherein the information provider is encouraged to continue/increase interactions with the MIC 20. For example, rewards can be increased if the information provider generates a predetermined amount of answers within an allotted time, or generates answers for more than one survey.

As input 24 is provided to MIC 20, responses 34 are provided to the user analysis component 30. The responses 34 are provided as a result of the information provider responding to the output 28. For example, the responses 34 may be in the form of answers such as yes/no, numerical/alphabetical responses based upon user inputs and selections (e.g., address, zip code, A, B), and substantially any form of communication/indication/selection from the information provider such as an audio response. As responses 34 are provided, the user analysis component 30 stores the responses 34 within a data store 38 for later retrieval and analysis. As will be described in more detail below, data mining and/or other analytical processing is provided by the user analysis component 30 to retrieve the responses 34 from the data store 38 and provide data in the form of research information 42 to an information users subsystem 48 (e.g., remote computer). As research information 42 is collected at the information users subsystem 48, interested parties (e.g., researchers, managers, marketers) may then utilize the information as desired. As will be described in more detail below, the information users subsystem 48 may direct queries and/or send modified information/surveys 50 to the user analysis component 30.

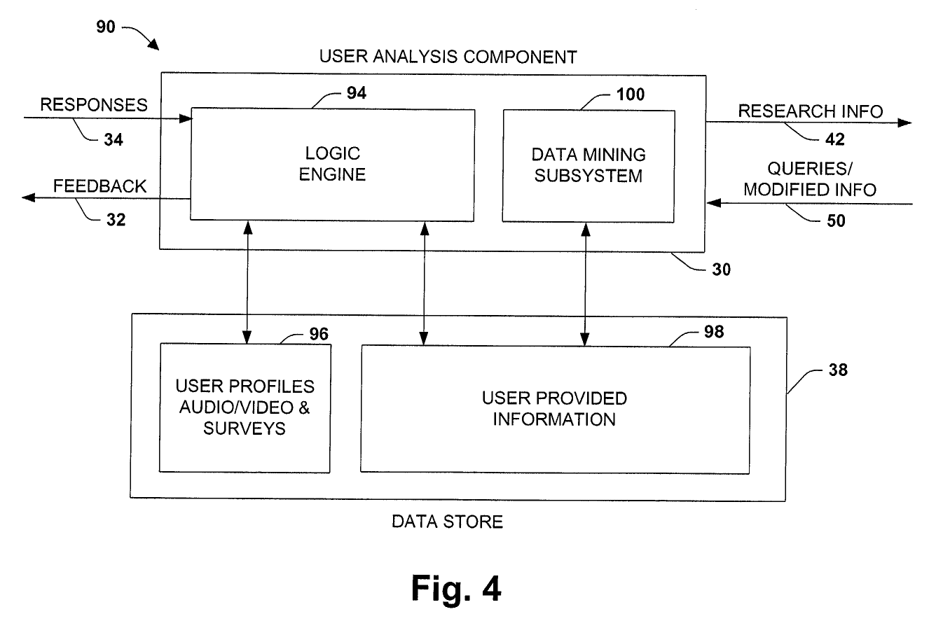

The user analysis component 30, which can be a computer, neural network, and/or other processing system, controls the interaction with the information provider via the feedback 32. This is achieved by analyzing the responses 34 and altering/changing the output 28 with the feedback 32. As will be described in more detail below, a logic engine (See e.g., FIG. 4) is employed within the user analysis component 30 to analyze the responses 34 according to user profiles stored in the data store 38. Based upon the responses 34, the logic engine determines feedback 32 that is tailored and crafted to the information provider. The feedback 32 can be in a plurality of forms such as music, text, video and audio streams directed to the information provider via the output 28. For example, after three responses 34, it may be determined that the information provider is a female, below age 30, and single. Suitable music, video, and demographic texts/surveys can then be directed to the information provider based upon user profiles stored in the data store 38 associated with single females below a predetermined age, for example.

After each response 34, and/or after a group of responses, the feedback 32 may be dynamically altered based upon predetermined rule sets and/or logic determinations assigned to demographics and/or other characteristics associated with the information provider. In this manner, the types of questions, rewards, surveys and/or entertainment options are focused to the information provider. For example, the single female under 30 may be directed toward answering questions/surveys relating to fashion products as opposed to questions relating to sports or related topics. It is to be appreciated however, that depending on the responses 34, that males and females, older or younger, affluent or conservative, may be provided with similar questions/surveys if it is determined that the information provider is interested in and/or motivated toward a particular topic.

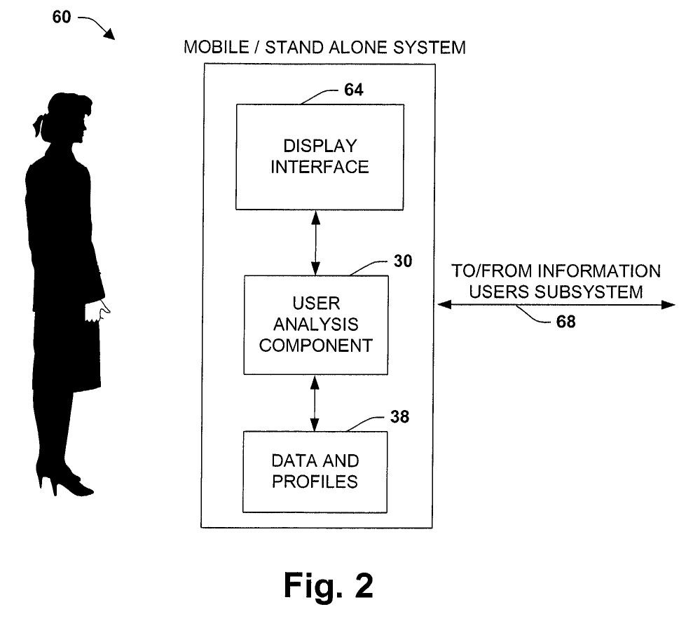

Turning now to FIG. 2, a mobile/standalone information and retrieval system 60 is illustrated in accordance with an aspect of the present invention. The system 60 is placed into areas or regions wherein consumers and information providers congregate. A display interface 64, such as a touch screen for example, is included for enabling interactions between information providers and the system 60. The MIC 30 and associated data store 38 is also included to drive the interface 64 as described above. A remote network connection 68 can be provided to enable transmissions of accumulated research information to remote locations and/or for receiving modified information from the remote locations to update the data store 38.

By placing or installing the system 60 in areas of congregation, information providers who are unlikely to participate in a focus group or other type of exchange of information may participate and interact with the system 60. For example, the system 60 may be configured into a free-standing structure such as a kiosk-display and placed into an airport or a shopping mall. As is well understood, much idle time is expended at airports and malls waiting for planes or in the case of malls waiting for someone else to finish a shopping engagement. While in wait, the system 60 offers entertainment and rewards as described above to those who have time and attitude to participate (e.g., get entertained/rewarded vs. do nothing/wait).

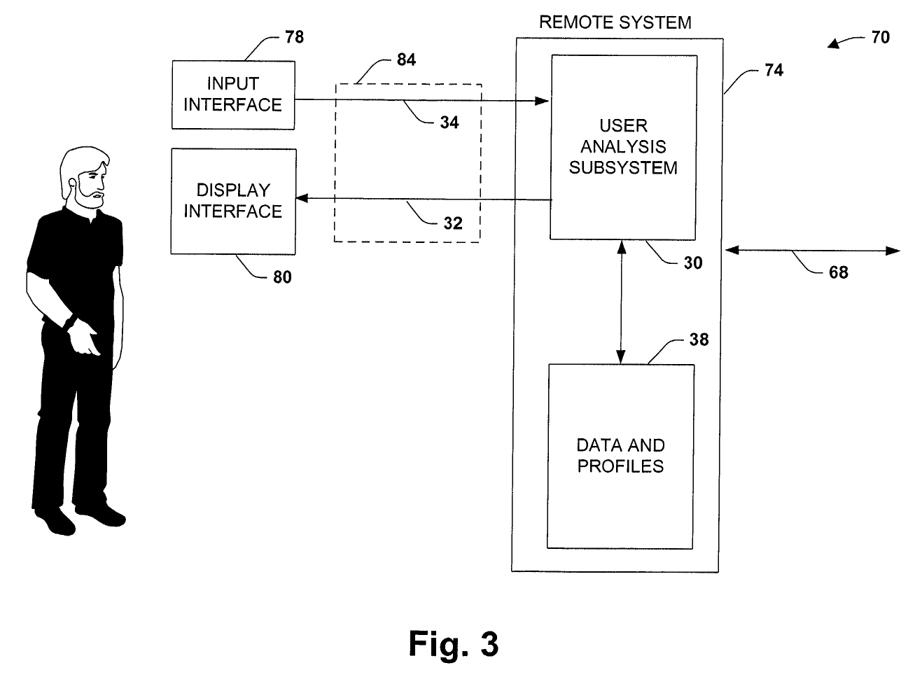

Referring now to FIG. 3, a remote information and retrieval system 70 is illustrated in accordance with the present invention. In accordance with this aspect of the invention, the user analysis component 30 and data store 38 are provided as part of a remote system 74. An input interface 78 and display interface 80 are operatively coupled to the remote system 74 via a wireless and/or network connection 84. For example, the input interface can be provided by a cellular phone, Personal Digital Assistant (PDA), hand-held computer, and substantially any interface for transmitting responses 34 to the remote system 74. Similarly, the display 80 can be provided by a hand-held computer, PDA, television, Internet display, and substantially any output interface for receiving feedback 32 from the remote system 74. In this manner, information providers may be offered incentives/rewards via the display interface 80 and can interact with the remote system 74 via the input interface 78.

It is noted, that various data compression techniques may be utilized when transmitting/receiving data over the network connection 84 and/or between operable components within the present invention. This may include storing/mining data to/from the data store 38 and to/from the remote system 74 in compressed formats. For example, this may include such data compression technologies as JPEG, MPEG, GIF, TIF, and wavelet compression technologies (e.g., Discrete Cosine Transform (DCT), Progressive Wavelet Coding (PWC)). Run-length and Huffman coding techniques can be applied to data as well as substantially any type of data compression process or algorithm. This can also include such commercially available technologies such as PKZIP/PKUNZIP for file size reduction and transmittal, for example. Audio and/or other video/image/data compression technologies may also be employed.

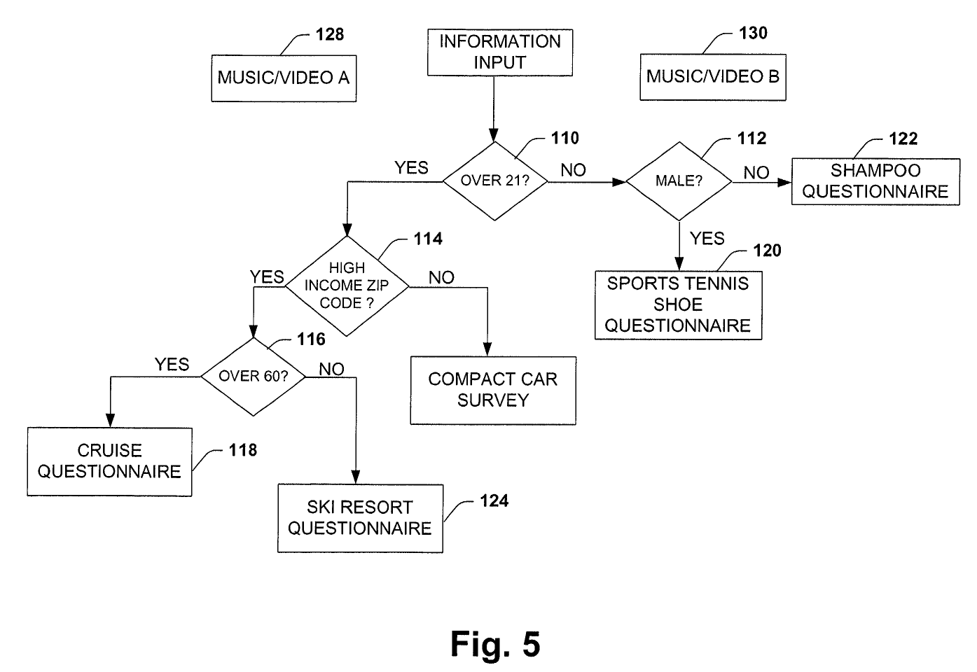

Turning now to FIG. 4, a system 90 illustrates a user analysis component 30 and data store 38 in more detail. As described above, the user analysis component 30 can include a logic engine 94 for analyzing responses 34 and providing feedback 32. This may be achieved by analyzing predetermined logic rule sets associated with characteristics, such as demographics, of potential information providers and providing feedback 32 that is related to the characteristics. Exemplary rule sets and logic engine determinations will be described in more detail below in relation to FIG. 5.

The data store 38 includes a plurality of feedback data 96 for providing feedback to the information provider. The feedback data 96 may include audio, video, text, and surveys in the form of questionnaires, for example. As an example, based upon the logic engine 94 determinations of responses 34, an audio, video, text and survey data may be retrieved from the feedback data 96 that are determined to be associated with characteristics of the information provider. For example, a male determined below the age of 21 may be provided with contemporary music and video feedback 32 and asked questions relating to categories associated with younger audiences (e.g., movies, video games, sports equipment). Similarly, incentives may be provided based upon the rule sets. As an example, a high-income male (e.g., determined from zip code) may be offered incentives relating to golf (e.g., rebate coupon for 1 dozen balls) and asked survey questions relating to higher priced automobiles (e.g., Lexis, Mercedes, BMW).

As responses 34 are received from the information provider, the logic engine 94 stores information in a database 98 relating to responses 34 from questionnaires and related demographics, for example. A data mining subsystem 100 may be employed to retrieve and collect the user provided information in the database 98. Data mining, which is well understood, provides a multi-dimensional access and organization to the database 98 wherein information is structured according to logical cubes and may be analyzed according to Online Analytical Processing (OLAP) techniques. For example, the database 98 may be mined according to relationships across survey categories and/or within survey categories to provide research information 42. For example, a search may be conducted from remote queries 50 of the database 98, for example, regarding relationships across multi-survey categories. As an example, a relationship may be discovered that many females above 21 who respond to compact car surveys were also influenced by high-quality sound systems. Likewise, survey information can be mined within a survey category. For example, mining may be conducted on all car survey respondents, on a particular car model survey respondent, and/or more narrowly defined to a particular type respondent within a defined survey category. As described above, updated and/or modified information may be provided to the user analysis component 30 wherein the feedback data 96 can be updated, modified, and adjusted in real-time.

Referring now to FIG. 5, an exemplary logic determination and rule set is illustrated. The logic engine can perform a plurality of determinations such as at reference numerals 110, 112, 114, and 116, for example, based upon the responses provided by the information provider. For example, if the information provider is over 60, from a high-income zip code, a cruise questionnaire 118 can be provided. If the information provider is determined to be a male below age 21, a sports tennis shoe questionnaire 120 may be provided, wherein a female below 21 may be provided a questionnaire 122 regarding shampoo, for example. Similarly, a high-income person below age 60 may be offered a ski resort questionnaire 124. It is noted that output feedback may be altered depending on the determined rule set. For example, if an information provider is determined to be above the age of 21, a music and/or video output “A” 128 can be provided as feedback, wherein if the provider is below 21, a music/video package “B” 130 may be offered. It is to be appreciated that the rules and determinations depicted in FIG. 5 are for exemplary purposes and that a plurality of other determinations, rules and surveys can be defined based upon demographics and/or other assumptions/profiles of potential information providers.

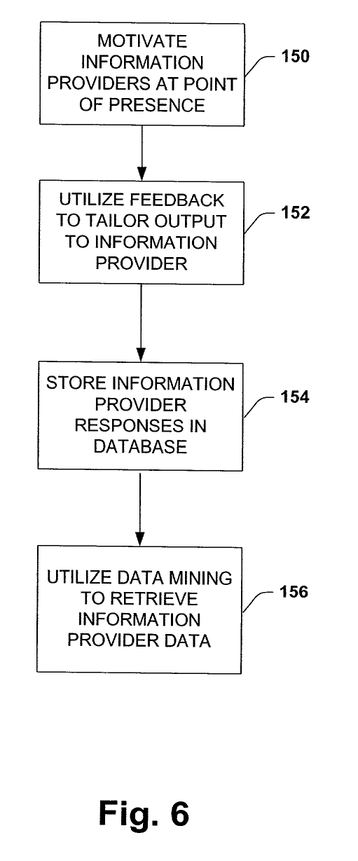

FIG. 6 illustrates a methodology for providing automatic information generation and retrieval in accordance with an aspect of the present invention. While, for purposes of simplicity of explanation, the methodology is shown and described as a series of acts, it is to be understood and appreciated that the present invention is not limited by the order of acts, as some acts, in accordance with the present invention, occur in different orders and/or concurrently with other acts from that shown and described herein. For example, those skilled in the art will understand and appreciate that a methodology could alternatively be represented as a series of interrelated states, such as in a state diagram. Moreover, not all illustrated acts may be required to implement a methodology in accordance with an aspect the present invention.

Referring to FIG. 6, a flow chart diagram illustrates a methodology for providing automatic information generation and retrieval. At 150, information providers are motivated at a point-of-presence to provide information. As described above, this may be achieved by providing entertainment/rewards as an incentive to participate, and may be administered via mobile/standalone systems and/or remotely. At 152, automated feedback is employed to tailor output to the information provider. As described above, rule sets may be employed wherein characteristics of the information provider are determined. Based upon the characteristics, video, audio, text, and/or survey offerings may be altered depending on the responses by the information provider. At 154, information provider responses are captured in a database. At 156, data mining is utilized to retrieve information associated with the information provider's responses. Upon retrieval, the information may be communicated to other systems for further processing.

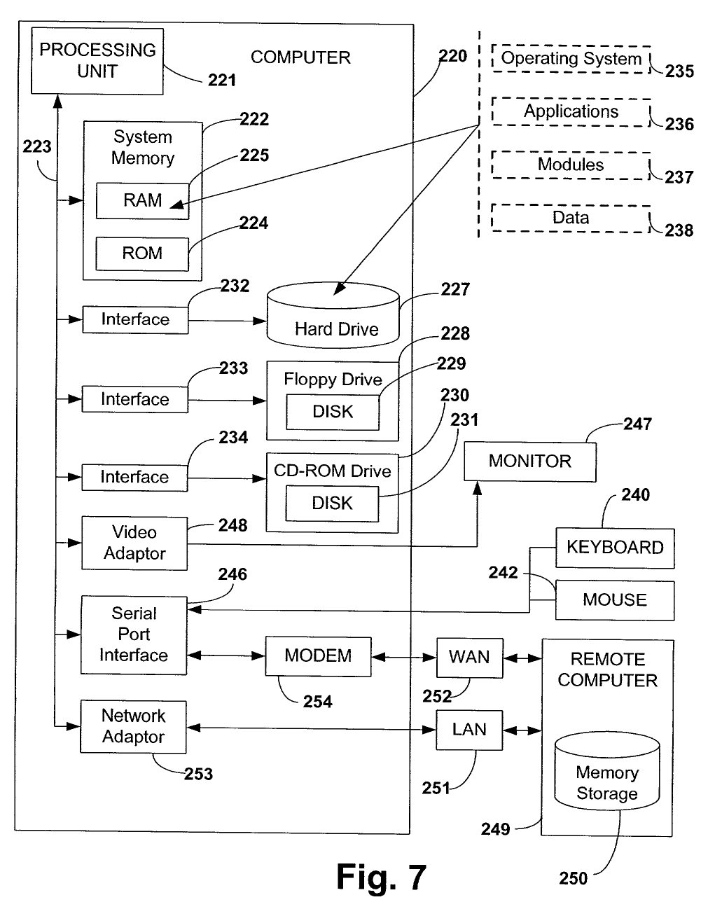

In order to provide a context for the various aspects of the invention, FIG. 7 and the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 7, an exemplary system for implementing the various aspects of the invention includes a computer 220, including a processing unit 221, a system memory 222, and a system bus 223 that couples various system components including the system memory to the processing unit 221. The processing unit 221 may be any of various commercially available processors. Dual microprocessors and other multi-processor architectures also may be employed as the processing unit 221. The system bus 223 may be any of several types of bus structure including a memory bus or memory controller, a peripheral bus, and a local bus using any of a variety of commercially available bus architectures. The system memory may include read only memory (ROM) 224 and random access memory (RAM) 225. A basic input/output system (BIOS), containing the basic routines that help to transfer information between elements within the computer 220, such as during start-up, is stored in ROM 224.

The computer 220 further includes a hard disk drive 227, a magnetic disk drive 228, e.g., to read from or write to a removable disk 229, and an optical disk drive 230, e.g., for reading from or writing to a CD-ROM disk 231 or to read from or write to other optical media. The hard disk drive 227, magnetic disk drive 228, and optical disk drive 230 are connected to the system bus 223 by a hard disk drive interface 232, a magnetic disk drive interface 233, and an optical drive interface 234, respectively. The drives and their associated computer-readable media provide nonvolatile storage of data, data structures, computer-executable instructions, etc. for the computer 220. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention. A number of program modules may be stored in the drives and RAM 225, including an operating system 235, one or more application programs 236, other program modules 237, and program data 238. The operating system 235 in the illustrated computer may be substantially any commercially available operating system.

A user may enter commands and information into the server computer 220 through a keyboard 240 and a pointing device, such as a mouse 242. Other input devices (not shown) may include a microphone, a joystick, a game pad, a satellite dish, a scanner, or the like. These and other input devices are often connected to the processing unit 221 through a serial port interface 246 that is coupled to the system bus, but may be connected by other interfaces, such as a parallel port, a game port or a universal serial bus (USB). A monitor 247 or other type of display device is also connected to the system bus 223 via an interface, such as a video adapter 248. In addition to the monitor, computers typically include other peripheral output devices (not shown), such as speakers and printers.

The computer 220 may operate in a networked environment using logical connections to one or more remote computers, such as a remote computer 249. The remote computer 249 may be a workstation, a server computer, a router, a peer device or other common network node, and typically includes many or all of the elements described relative to the computer 220, although only a memory storage device 250 is illustrated in FIG. 7. The logical connections depicted in FIG. 7 may include a local area network (LAN) 251 and a wide area network (WAN) 252. Such networking environments are commonplace in offices, enterprise-wide computer networks, Intranets and the Internet.

When employed in a LAN networking environment, the computer 220 may be connected to the local network 251 through a network interface or adapter 253. When utilized in a WAN networking environment, the computer 220 generally may include a modem 254, and/or is connected to a communications server on the LAN, and/or has other means for establishing communications over the wide area network 252, such as the Internet. The modem 254, which may be internal or external, may be connected to the system bus 223 via the serial port interface 246. In a networked environment, program modules depicted relative to the computer 220, or portions thereof, may be stored in the remote memory storage device. It will be appreciated that the network connections shown are exemplary and other means of establishing a communications link between the computers may be employed.

In accordance with the practices of persons skilled in the art of computer programming, the present invention has been described with reference to acts and symbolic representations of operations that are performed by a computer, such as the computer 220, unless otherwise indicated. Such acts and operations are sometimes referred to as being computer-executed. It will be appreciated that the acts and symbolically represented operations include the manipulation by the processing unit 221 of electrical signals representing data bits which causes a resulting transformation or reduction of the electrical signal representation, and the maintenance of data bits at memory locations in the memory system (including the system memory 222, hard drive 227, floppy disks 229, and CD-ROM 231) to thereby reconfigure or otherwise alter the computer system's operation, as well as other processing of signals. The memory locations wherein such data bits are maintained are physical locations that have particular electrical, magnetic, or optical properties corresponding to the data bits.

What has been described above are preferred aspects of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system providing automatic generation and retrieval of consumer information, comprising:
an interactive component to motivate consumers to provide information input; and
an analytical component providing feedback to the interactive component based upon profiles associated with the information input.

2. The system of claim 1, wherein the interactive and analytical components are configured as a mobile/standalone system to provide point-of-presence interactions with consumers.

3. The system of claim 1, wherein the interactive and analytical components are separated to provide remote interactions with consumers.

4. The system of claim 1, wherein the interactive component provides entertainment and rewards to induce interactions with consumers.

5. The system of claim 4, wherein the rewards further comprise at least one of: money, coupons, rebates, and credits.

6. The system of claim 4, wherein the entertainment further comprises at least one of music, video, audio, and challenges such as brain teasers, factoids, quizzes, and video games.

7. The system of claim 1, wherein the analytical component further comprises a logic engine for interpreting at least one rule set to determine the feedback provided to the consumer.

8. The system of claim 7, wherein the rule set is determined from demographic characteristics of the consumer.

9. The system of claim 7, wherein surveys are directed to the consumer based upon the rule set.

10. The system of claim 1, wherein the analytical component further comprises a data store for storing responses from the consumer.

11. The system of claim 10, further comprising a data mining subsystem for retrieving responses provided by the consumer.

12. A method providing automatic generation and retrieval of consumer information, comprising:
motivating an information provider at a point-of-presence associated with the information provider;
utilizing automated feedback to tailor output to the information provider;
storing the information provider's response to the output in a database; and
data mining the database to retrieve information associated with the information provider.

13. The method of claim 12, wherein the point-of-presence is provided via a mobile/standalone system.

14. The method of claim 12, wherein the point-of-presence is provided via remote interactions with the information providers.

15. The method of claim 12, further comprising:
providing entertainment and rewards to induce interactions with information providers.

16. The method of claim 15, wherein the rewards further comprise at least one of:
providing money, coupons, rebates, and credits.

17. The method of claim 15, wherein the entertainment further comprises at least one of:
providing music, video, audio, and challenges such as brain teasers, factoids, quizzes, and video games.

18. The method of claim 12, further comprising:
interpreting at least one rule set to determine the feedback provided to the information provider.

19. The method of claim 18, wherein the rule set is determined from demographic characteristics of the information provider.

20. A system providing automatic generation and retrieval of consumer information, comprising:
means for motivating an information provider at a point-of-presence associated with the information provider;
means for utilizing automated feedback to tailor output to the information provider;
means for storing the information provider's response to the output in a database; and
means for data mining the database to retrieve information associated with the information provider.

21. A computer readable medium having computer executable components, comprising:
an interactive component to motivate consumers to provide information input; and
an analytical component providing feedback to the interactive component based upon profiles associated with the information input.

22. A data packet adapted to be transmitted between at least two processes, comprising:
an interactive component to motivate consumers to provide information input; and
an analytical component providing feedback to the interactive component based upon profiles associated with the information input.

23. A computer readable medium having stored thereon a data structure, comprising:
a first data field containing data representing information provided by consumers in response to interacting with a system to motivate the consumers to provide the information, the consumer motivation being respective functions of profiles of the consumers; and
a second data field containing data representing results from an analysis system which analyzed the information based at least upon respective profiles of the consumers.
